(19) United States
(12) Patent Application Publication
(10) Pub. No.: US 2024/0338597 A1
(43) Pub. Date: Oct. 10, 2024

(54) USING MACHINE LEARNING TO GENERATE A WORKLOAD OF A STORAGE COMPONENT

(71) Applicant: Micron Technology, Inc., Boise, ID (US)

(72) Inventors: Saideep TIKU, Folsom, CA (US); Poorna KALE, Folsom, CA (US)

(21) Appl. No.: 18/596,108

(22) Filed: Mar. 5, 2024

Related U.S. Application Data
(60) Provisional application No. 63/494,071, filed on Apr. 4, 2023.

(51) Int. Cl. G06N 20/00

(52) U.S. Cl. CPC G06N 20/00

(57) ABSTRACT

Implementations described herein relate to using machine learning to generate a workload of a storage component. In some implementations, a device may obtain first data relating to commands issued by an operating system of a compute component of a computer system for a storage component of the computer system. The device may obtain second data relating to transactions at the storage component that are responsive to the commands. The device may provide the first data and the second data to train a machine learning model to output generated storage transactions based on an input of operating system commands.

### CROSS REFERENCE TO RELATED APPLICATION

This Patent Application claims priority to U.S. Provisional Patent Application No. 63/494,071, filed on Apr. 4, 2023, and entitled “USING MACHINE LEARNING TO GENERATE A WORKLOAD OF A STORAGE COMPONENT.” The disclosure of the prior Application is considered part of and is incorporated by reference into this Patent Application.

### TECHNICAL FIELD

The present disclosure generally relates to computer systems and, for example, to using machine learning to generate a workload of a storage component.

### BACKGROUND

A computer system may include a combination of a processor, a memory, and/or an input/output device. An embedded system is a computer system that has a dedicated function within a larger mechanical system or electronic system. In some examples, an embedded system may include a system-on-chip (SoC) device, one or more memory devices, and/or one or more storage devices on a common circuit board.

### BRIEF DESCRIPTION OF THE DRAWINGS

FIG. 1 is a diagram illustrating an example associated with training of a machine learning model in connection with generating a workload of a storage component.

FIG. 2 is a diagram illustrating an example associated with use of a machine learning model in connection with generating a workload of a storage component.

FIG. 3 is a diagram of an example environment in which systems and/or methods described herein may be implemented.

FIG. 4 is a diagram of example components of a device associated with using machine learning to generate a workload of a storage component.

FIG. 5 is a flowchart of an example method associated with using machine learning to generate a workload of a storage component.

FIG. 6 is a flowchart of an example method associated with using machine learning to generate a workload of a storage component.

### DETAILED DESCRIPTION

As described above, an embedded system (also known as an “embedded platform”) is a computer system that may have a dedicated function within a larger mechanical or electronic system. The embedded system may include a computation component (e.g., a system-on-chip (SoC) device) and one or more storage components (e.g., one or more memory devices and/or one or more storage devices) on a common circuit board. The computation component may implement an operating system (e.g., firmware), and the operating system may issue commands for a storage component, such as read commands (e.g., commands instructing the storage component to read data from storage and provide that data to the computation component) and/or write commands (e.g., commands instructing the storage component to write data to storage), referred to herein as “read-write commands,” or other commands, such as refresh commands, erase commands, garbage collection commands, or other housekeeping commands. Because the embedded system may have a specific function or purpose, particular commands may be frequently issued by the operating system in accordance with the specific function or purpose.

Based on the issued commands, the storage component may transmit and/or receive data and/or commands as electrical signals. A relationship between the issued commands and the data and/or commands communicated at the storage component (e.g., a manner in which the issued commands will be handled internally at the storage component) may be unknown, or difficult to ascertain or predict. As a result, a configuration of the storage component may not be optimized to respond to the commands that are commonly issued in the embedded system in an efficient manner. Accordingly, operations of the embedded system may be performed relatively slowly, thereby causing excessive consumption of power resources and/or computing resources.

Some implementations described herein provide synthetically generated workloads of a storage component. In some implementations, a machine learning model may be trained to generate storage transactions (e.g., data and command transactions) for a storage component that are responsive to commands issued by an operating system. For example, the machine learning model may be a generative model that is trained using data relating to commands issued by an operating system and data relating to transactions at a storage component that are responsive to the issued commands. An interposer may be connected to the storage component to capture electrical signals at the storage component, which may then be analyzed and converted to transaction descriptions (e.g., commands) used for training.

The generated storage transactions may indicate how a computer system that includes the storage component would operate in response to various issued commands, thereby facilitating optimization of the computer system. The computer system may be an existing computer system or a conceptual, next-generation computer system. The computer system may be optimized based on the generated storage transactions (e.g., by adjusting a configuration of the computer system). For example, a configuration of the storage component may be tuned to handle the types of issued commands provided by a compute component of the computer system. In this way, the computer system may operate faster and more efficiently, thereby reducing the computer system's consumption of power resources and/or computing resources.

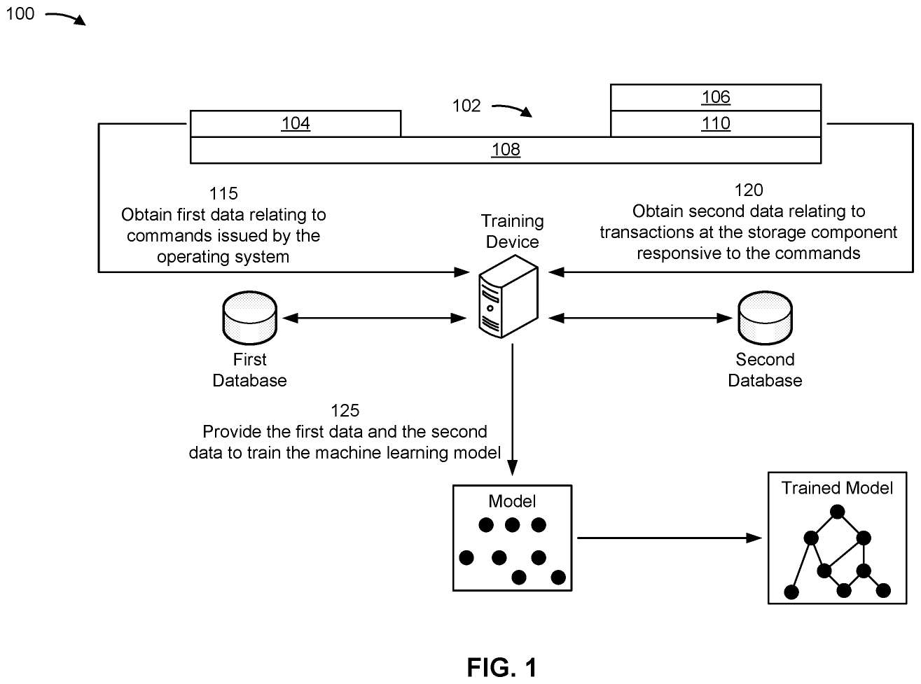

FIG. 1 is a diagram illustrating an example 100 associated with training of a machine learning model in connection with generating a workload of a storage component. Example 100 includes a training device. As described herein, the training device may perform operations to train the machine learning model. Example 100 also includes a computer system 102. The computer system 102 may be an embedded system. The computer system 102 may include a compute component 104 and a storage component 106, which may be disposed on a common circuit board 108 (e.g., a printed circuit board (PCB)) of the computer system 102. The compute component 104 may include an SoC device. For example, the compute component 104 may include one or more processing units (e.g., one or more central processing units (CPUs) and/or one or more graphics processing units (GPUs)) and/or one or more cache memories (e.g., a level 1 (L1) cache, a level 2 (L2) cache, a level 3 (L3) cache, or the like), among other examples. The compute component 104 may implement an operating system (e.g., firmware). The storage component 106 may include one or more memory devices (e.g., one or more random access memory (RAM) devices, one or more dynamic RAM (DRAM) devices, and/or one or more synchronous dynamic RAM (SDRAM) devices, among other examples) and/or one or more storage devices (e.g., one or more solid state drives (SSDs), one or more flash memory devices, one or more NAND memory devices, one or more NOR memory devices, and/or one or more hard disk drives, among other examples).

As shown in FIG. 1, and by reference number 115, the training device may obtain first data relating to commands (e.g., read-write commands, refresh commands, erase commands, garbage collection commands, or the like) issued by the operating system (e.g., by an operating system stack) of the compute component 104 for the storage component 106. As an example, the issued commands may include small computer system interface (SCSI) commands. The first data may indicate events and/or operations, such as event and/or operation traces (e.g., across the operating system stack), associated with the issued commands.

To obtain the first data, the training device may monitor (e.g., collect), via an application (e.g., a tracing application) and/or hardware, commands issued by the operating system for block storage (e.g., reads and/or writes to block devices, such as storage devices, from the perspective of the operating system stack). For example, this may indicate the commands issued to a storage device of the storage component 106 from the perspective of the operating system. Additionally, or alternatively, to obtain the first data, the training device may monitor (e.g., collect), via the application, issued commands (e.g., read and/or write operations) indicated by a page cache and/or kernel content (e.g., a cache, a log, a mapping) stored in memory (e.g., stored in RAM). For example, this may indicate the commands issued to a memory device of the storage component 106 from the perspective of the operating system.

The training device may cause the first data that is obtained to be stored in a first database. Additionally, or alternatively, to obtain the first data, the training device may retrieve the first data from the first database (e.g., when the first data has been previously collected and stored in the first database by the training device or another device).

As shown by reference number 120, the training device may obtain second data relating to transactions at the storage component 106 that are responsive to the commands issued by the operating system. For example, the transactions at the storage component 106 indicate how the commands issued by the operating system are actually handled at the storage component 106. The transactions may include data and/or command transactions (e.g., data and/or command traces, relating to a sequence of storage events) relating to data and/or commands (e.g., commands and/or addresses) that are transmitted and/or received by the storage component 106. For example, the data and/or command transactions may include information (e.g., commands) transmitted via a command address (CA) bus (e.g., command signals and/or address signals). The second data may indicate events and/or operations, such as event and/or operation traces, associated with the issued commands.

The storage component 106 may transmit and/or receive the data and/or commands as electrical signals. Accordingly, an interposer 110 may be disposed between the storage component 106 and the circuit board 108 of the computer system 102. For example, prior to the operations of example 100, the storage component 106 may be removed and replaced on the circuit board 108 to allow the interposer 110 to be connected to the storage component 106 and placed between the storage component 106 and the circuit board 108. The interposer may be configured to route electrical signals communicated by the storage component 106 to a location external to the computer system 102 (e.g., to the training device or another device that is collecting the second data). For example, the interposer 110 may expose the pins of the storage component 106 so that data and/or commands being transmitted and/or received by the storage component 106 may be captured.

To obtain the second data, the training device may obtain electrical signal data by monitoring (e.g., collecting), via the interposer 110, electrical signals communicated at the storage component 106. For example, the training device may obtain the electrical signal data using a logic analyzer configured to generate information indicating when pins on the storage component 106 are at a high voltage or at a low voltage. Thus, the electrical signal data may indicate binary data. Moreover, to obtain the second data, the training device may convert the electrical signal data (e.g., the binary data) to one or more data and/or command transactions for the storage component 106. For example, the training device may convert the electrical signal data using a protocol analyzer configured to generate information indicating individual commands that are indicated by the electrical signal data.

The training device may cause the second data that is obtained to be stored in a second database. Additionally, or alternatively, to obtain the second data, the training device may retrieve the second data from the second database (e.g., when the second data has been previously collected and stored in the second database by the training device or another device).

In some implementations, the training device may obtain third data indicating a hardware configuration and/or an application configuration of the computer system 102 (e.g., of the compute component 104). For example, the training device may obtain the third data from a third database and/or the third data may be input to the training device by an operator of the training device. The hardware configuration may indicate a quantity of CPU cores of the compute component 104, a quantity of GPU cores of the compute component 104, and/or an amount of L1 cache, L2 cache, and/or L3 cache of the compute component 104, among other examples. The application configuration may indicate one or more applications that are configured to execute on the computer system 102, such as when the first data and the second data are obtained (e.g., the issued commands of the first data may originate from the applications).

The first data, the second data, and the third data, in addition to including data relating to the computer system 102, may include data relating to one or more additional computer systems (e.g., tens, hundreds, or thousands of additional computer systems), which may be obtained in a similar manner as described above. The additional computer systems may have respective different hardware configurations and/or application configurations from a hardware configuration and/or application configuration of the computer system (e.g., each computer system may have a distinct hardware configuration and/or application configuration). However, the hardware configurations and/or application configurations of the computer systems may be similar to each other.

The first data and the second data may be training data for training the machine learning model. As shown by reference number 125, the training device, after obtaining the first data and the second data, may provide the first data and the second data to train the machine learning model. The first data and the second data may train the machine learning model to output generated storage transactions (e.g., data and/or command transactions) based on an input of operating system commands (e.g., read-write commands, or other commands, issued by an operating system). For example, the first data and the second data may indicate that given the commands issued by the operating system as input produces the data (e.g., which may be dummy data) and command transactions (e.g., data and command traces) that were captured from the storage component 106 by the interposer 110.

In some implementations, the training device may provide the first data, the second data, and the third data as training data to train the machine learning model. For example, the third data may indicate a hardware configuration and/or an application configuration of the computer system 102 (e.g., of the compute component 104). The third data may be provided to the machine learning model as a vector-based description of the third data (e.g., as one or more tensors).

The machine learning model may be a deep-learning model, such as an artificial neural network model. The machine learning model may be a generative model. For example, the machine learning model may be a variational autoencoder (VAE) model or a conditional VAE model (e.g., when the third data is used). As another example, the machine learning model may be a generative adversarial network (GAN) model or a conditional GAN model (e.g., when the third data is used). The machine learning model may be trained using the training data described herein (e.g., the first data, the second data, and/or the third data). This training may include executing, by the training device, a machine learning algorithm (e.g., an artificial neural network algorithm) to determine a set of model parameters based on the training data. The machine learning model may be trained, using the training data, to generate a new instance of data (e.g., one or more storage transactions) that is not found in the training data.

A VAE may learn a distribution of data in the training data, which the VAE can use to generate new data by sampling from the distribution. The VAE may include an encoder network and a decoder network. The encoder network may convert data points in the training data into a lower-dimensional latent space (also known as an “embedding space”). For example, the encoder network may learn a distribution of latent (hidden) variables that represent attributes found in the training data (e.g., a quantity of commands issued over a particular time period, a quantity of commands issued in a particular address range (e.g., a logical block addressing (LBA) range), and/or a quantity of issued commands attributable to a particular application, among other examples). The latent variables may define position in the latent space, where data points resembling each other are positioned closer to each other in the latent space. The decoder network may convert data points in the latent space into a probability distribution of data in the training dataset. Thus, samples from the latent space may be input to the decoder network to generate new data (e.g., storage transactions) that is similar to data points in the training data. For example, the decoder network may convert the samples into data points corresponding to latent variable values in the latent space. A conditional VAE is similar to a VAE, except that the conditional VAE may be trained to generate new data that is in accordance with additional information (e.g., a hardware configuration and/or an application configuration of the compute component 104).

A GAN may include a generator network and a discriminator network. The generator network and the discriminator network may be artificial neural networks. The discriminator network may be used for training the generator network to generate new data (e.g., storage transactions) that is statistically similar to the training data. The discriminator network may be trained, using the training data, to identify whether input data to the discriminator network includes a pattern found in the training data (e.g., a quantity of commands issued over a particular time period, a quantity of commands issued in a particular address range (e.g., an LBA range), and/or a quantity of issued commands attributable to a particular application, among other examples). The generator network may be trained to generate new data that includes patterns similar to the pattern found in the training data. An output of the generator network (e.g., generated storage transactions) may be provided as input data to the discriminator network (e.g., as well as the issued commands associated with the generated storage events), and the discriminator network may determine whether the input data includes the pattern found in the training data (e.g., whether the generated storage transactions are a real response or a fake response to the issued commands). An output of the discriminator network may be back propagated through the generator network to configure (or reconfigure) parameters of the generator network (e.g., weight values used for nodes of the generator network). A conditional GAN is similar to a GAN, except that the conditional GAN may be trained to generate new data that is in accordance with additional information (e.g., a hardware configuration and/or an application configuration of the compute component).

As indicated above, FIG. 1 is provided as an example. Other examples may differ from what is described with regard to FIG. 1.

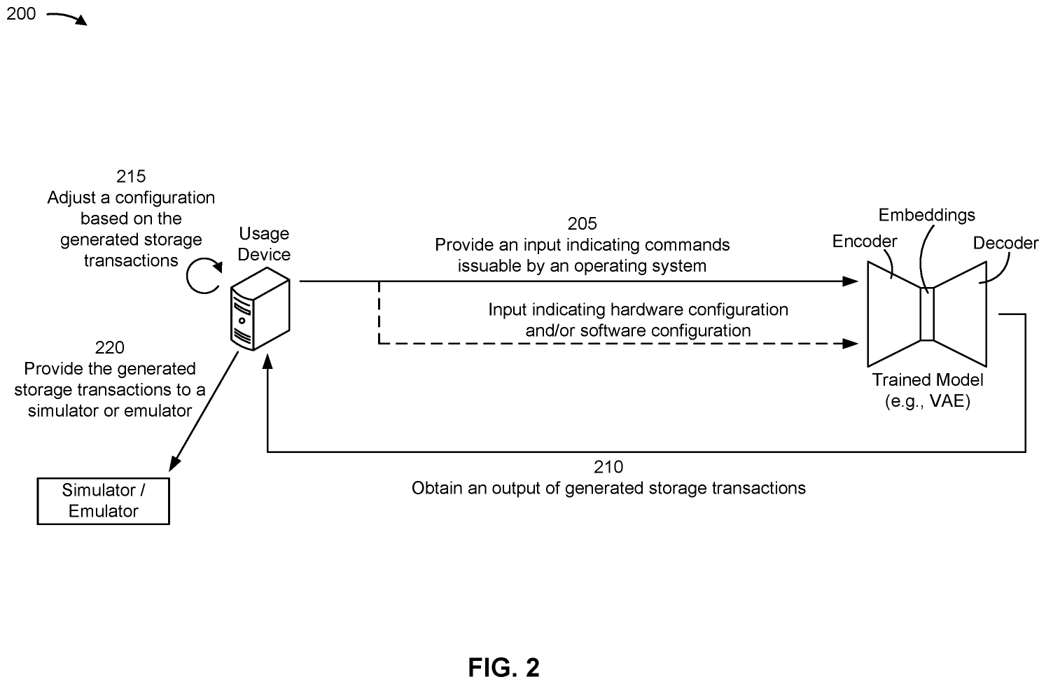

FIG. 2 is a diagram illustrating an example 200 associated with use of a machine learning model in connection with generating a workload of a storage component.

Example 200 includes a usage device. As described herein, the usage device may perform operations in connection with a use of a machine learning model that is trained as described in connection with FIG. 1. In some implementations, the training device, described in connection with FIG. 1, may include the usage device, may be included in the usage device, or may be included in a system with the usage device. In some implementations, the usage device may be a computer system (e.g., an embedded system) that includes a compute component and a storage component disposed on a common circuit board, in a similar manner as described in connection with FIG. 1. The usage device may implement the machine learning model, such as the machine learning model described in connection with FIG. 1 (e.g., that includes a decoder network of a VAE or a generator network of a GAN). In some implementations, the machine learning model may be implemented by another device that communicates with the usage device in connection with inputs and outputs of the machine learning model.

As shown in FIG. 2, and by reference number 205, the usage device may provide, to the machine learning model (shown as a VAE, but the machine learning model may be another type of model), an input indicating one or more commands (e.g., a plurality of commands) issuable by an operating system of a compute component of a computer system. For example, the commands may be commands that could theoretically be issued by the operating system or commands that have actually been issued by the operating system. The input may relate to the computer system as a whole, or the input may be particular to one or more applications of the computer system.

In some implementations, the input may further indicate a hardware configuration of the computer system (e.g., of the compute component) and/or an application configuration of the computer system (e.g., of the compute component), in a similar manner as described above. For example, the hardware configuration and/or the application configuration may be input to the machine learning model as a vector-based description (e.g., as one or more tensors).

The computer system may be an existing computer system (e.g., the usage device may be the computer system). For example, the hardware configuration and/or the application configuration may be a possible hardware configuration and/or application configuration of the existing computer system (e.g., but that is not currently being used by the existing computer system). In this way, the machine learning model enables in-field optimization of the existing computer system. Alternatively, the computer system may be a conceptual (e.g., non-existing) computer system. For example, the hardware configuration and/or the application configuration may be a possible hardware configuration and/or application configuration of the conceptual computer system. In this way, the machine learning model enables testing of next-generation computer systems (e.g., before such systems have been realized).

As shown by reference number 210, the usage device may obtain, from the machine learning model, an output of generated storage transactions (e.g., data and command transactions) for a storage component (e.g., one or more memory devices and/or one or more storage devices) of the computer system responsive to the issued commands. For example, the generated storage transactions may be storage transactions that could plausibly result at the storage component responsive to the issued commands. The generated storage transactions may include data and/or command transactions (e.g., data and/or command traces) relating to data and/or commands (e.g., commands and/or addresses) that could be transmitted and/or received by the storage component responsive to the issued commands (e.g., information (e.g., commands) transmitted via a command address (CA) bus). For example, the output may represent a workload (e.g., a synthetic workload) for the storage component resulting from the issued commands. In this way, the machine learning model may generate synthetic workloads for the computer system.

As shown by reference number 215, the usage device (e.g., when the usage device is the computer system) may adjust a configuration for the compute component and/or the storage component based on the generated storage transactions. For example, the adjusted configuration may indicate one or more selections of options for the compute component (e.g., a quantity of CPU cores that are to be active) and/or the storage component (e.g., a memory address location that is to be used). The usage device may configure itself based on the configuration (e.g., when the usage device is the computer system), or the usage device may transmit the configuration to another device (e.g., to the computer system) for implementation on the computer system. In this way, the configuration may facilitate tuning of the computer system for optimal operation.

As shown by reference number 220, the usage device (e.g., when the computer system is conceptual) may provide the generated storage transactions to a simulator for the computer system or an emulator for the computer system. For example, the simulator/emulator may be for a conceptual computer system. The simulator/emulator may process a workload of the generated storage transactions and generate information indicative of changes to the computer system that would better suit the workload. The simulator/emulator may be implemented on the usage device or on another device.

Accordingly, the computer system may be optimized based on the generated storage transactions (e.g., by adjusting a configuration of the computer system). For example, a configuration of the storage component may be tuned to better suit the types of issued commands provided by the compute component of the computer system. In this way, the computer system may operate faster and more efficiently, thereby reducing the computer system's consumption of power resources and/or computing resources.

As indicated above, FIG. 2 is provided as an example. Other examples may differ from what is described with regard to FIG. 2.

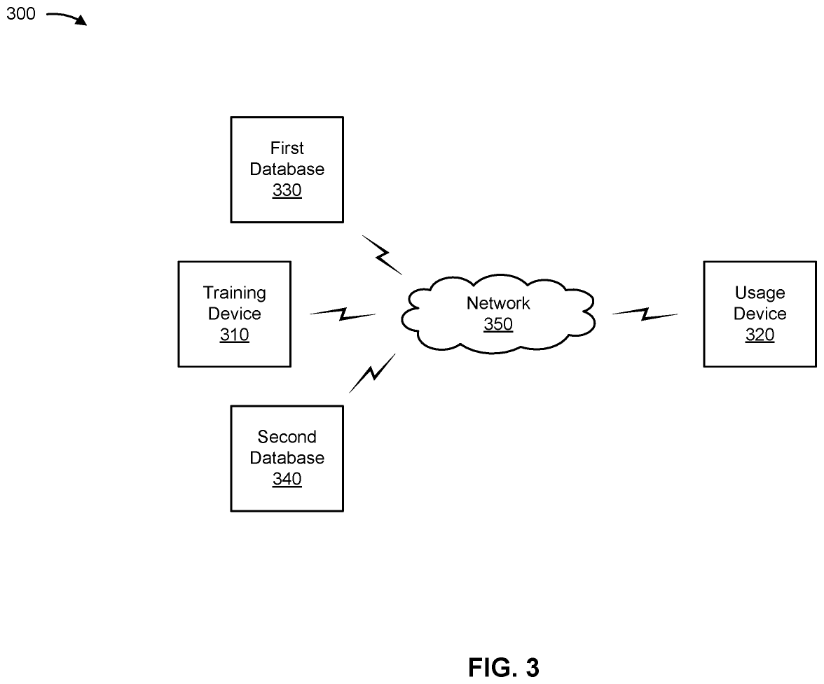

FIG. 3 is a diagram of an example environment 300 in which systems and/or methods described herein may be implemented. As shown in FIG. 3, environment 300 may include a training device 310, a usage device 320, a first database 330, and a second database 340, and a network 350. Devices of environment 300 may interconnect via wired connections, wireless connections, or a combination of wired and wireless connections.

The training device 310 may include one or more devices capable of receiving, generating, storing, processing, providing, and/or routing information associated with training of a machine learning model in connection with generating a workload of a storage component, as described elsewhere herein. The training device 310 may include a communication device and/or a computing device. For example, the training device 310 may include a server, such as an application server, a client server, a web server, a database server, a host server, a proxy server, a virtual server (e.g., executing on computing hardware), or a server in a cloud computing system. In some implementations, the training device 310 may include computing hardware used in a cloud computing environment.

The usage device 320 may include one or more devices capable of receiving, generating, storing, processing, providing, and/or routing information associated with use of a machine learning model in connection with generating a workload of a storage component, as described elsewhere herein. The usage device 320 may include a communication device and/or a computing device. For example, the usage device 320 may include a server, such as an application server, a client server, a web server, a database server, a host server, a proxy server, a virtual server (e.g., executing on computing hardware), or a server in a cloud computing system. In some implementations, the usage device 320 may include computing hardware used in a cloud computing environment. In some implementations, the training device 310 and the usage device 320 may be the same device, or may be included in the same device. In some implementations, the usage device 320 may include, or may be included in, the training device 310.

The first database 330 may include one or more devices capable of receiving, generating, storing, processing, and/or providing information associated with training of a machine learning model in connection with generating a workload of a storage component, as described elsewhere herein. The first database 330 may include a communication device and/or a computing device. For example, the first database 330 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the first database 330 may store information relating to commands issued by an operating system, as described elsewhere herein.

The second database 340 may include one or more devices capable of receiving, generating, storing, processing, and/or providing information associated with training of a machine learning model in connection with generating a workload of a storage component, as described elsewhere herein. The second database 340 may include a communication device and/or a computing device. For example, the second database 340 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the second database 340 may store information relating to storage transactions at a storage component, as described elsewhere herein. In some implementations, the first database 330 and the second database 340 may be the same device or data structure, or may be included in the same device or data structure. In some implementations, the second database 340 may include, or may be included in, the first database 330.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

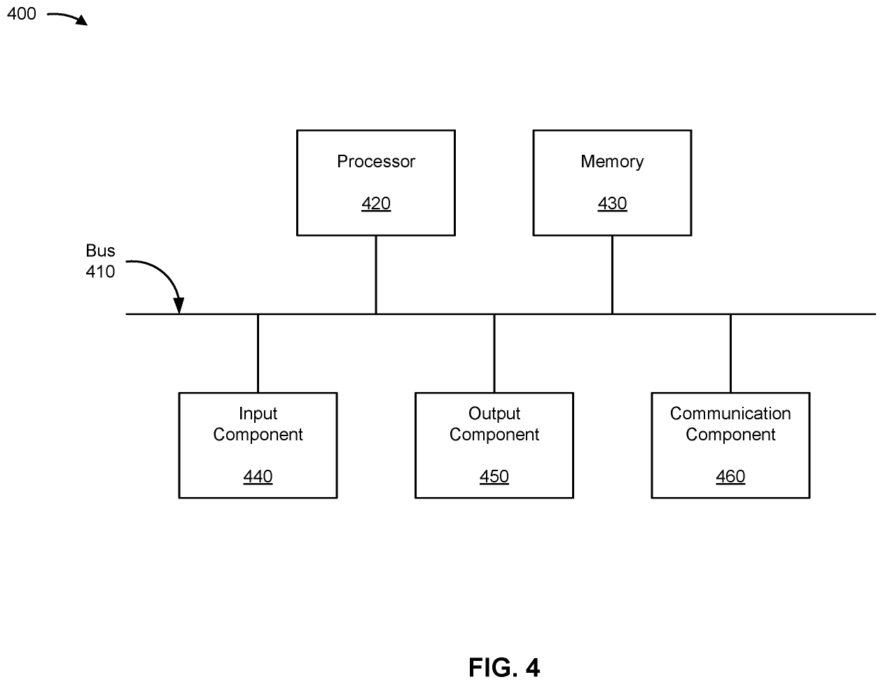

FIG. 4 is a diagram of example components of a device 400 associated with using machine learning to generate a workload of a storage component. The device 400 may correspond to training device 310, usage device 320, first database 330, and/or second database 340. In some implementations, training device 310, usage device 320, first database 330, and/or second database 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include RAM, read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

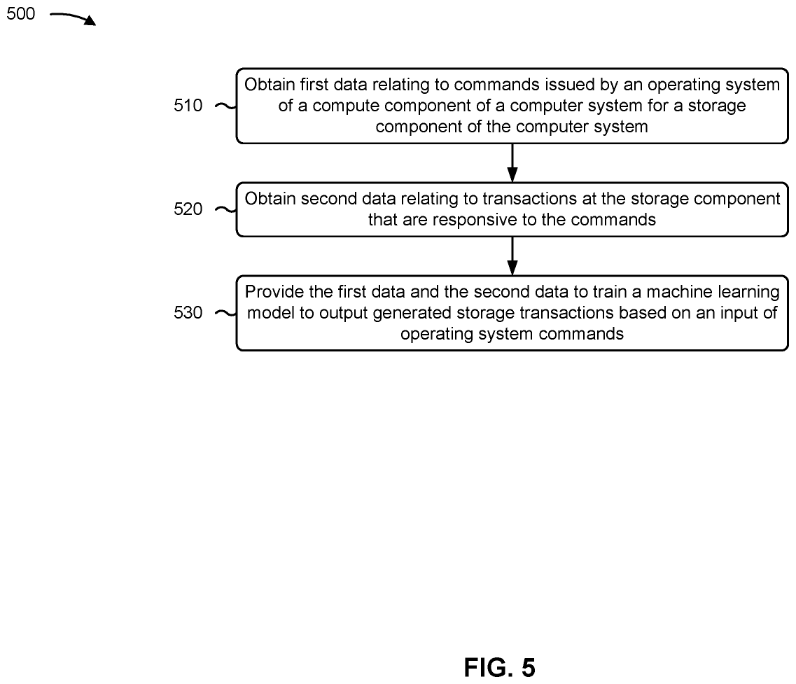

FIG. 5 is a flowchart of an example method 500 associated with using machine learning to generate a workload of a storage component. In some implementations, a device (e.g., the training device 310) may perform or may be configured to perform the method 500. In some implementations, another device or a group of devices separate from or including the device (e.g., usage device 320, the first database 330, and/or the second database 340) may perform or may be configured to perform the method 500. Additionally, or alternatively, one or more components of the device may perform or may be configured to perform the method 500. Thus, means for performing the method 500 may include the device and/or one or more components of the device. Additionally, or alternatively, a non-transitory computer-readable medium may store one or more instructions that, when executed by the device, cause the device to perform the method 500.

As shown in FIG. 5, the method 500 may include obtaining first data relating to commands issued by an operating system of a compute component of a computer system for a storage component of the computer system (block 510). As further shown in FIG. 5, the method 500 may include obtaining second data relating to transactions at the storage component that are responsive to the commands (block 520). As further shown in FIG. 5, the method 500 may include providing the first data and the second data to train a machine learning model to output generated storage transactions based on an input of operating system commands (block 530).

The method 500 may include additional aspects, such as any single aspect or any combination of aspects described below and/or described in connection with one or more other methods or operations described elsewhere herein.

In a first aspect, providing the first data and the second data to train the machine learning model includes providing the first data, the second data, and third data to train the machine learning model, where the third data indicates a hardware configuration of the computer system.

In a second aspect, alone or in combination with the first aspect, the third data further indicates an application configuration of the computer system.

In a third aspect, alone or in combination with one or more of the first and second aspects, obtaining the first data includes obtaining the first data by monitoring, via an application executing on the compute component, the commands, where the commands are for block storage.

In a fourth aspect, alone or in combination with one or more of the first through third aspects, obtaining the first data includes obtaining the first data by monitoring, via an application executing on the compute component, the commands, where the commands are indicated by at least one of a page cache or kernel content stored in memory.

In a fifth aspect, alone or in combination with one or more of the first through fourth aspects, an interposer is disposed between the storage component and a circuit board of the computer system, where the interposer is configured to route electrical signals communicated by the storage component to a location external to the computer system.

In a sixth aspect, alone or in combination with one or more of the first through fifth aspects, obtaining the second data includes obtaining electrical signal data by monitoring, via an interposer connected to the storage component, electrical signals communicated at the storage component, and converting the electrical signal data to one or more data and command transactions for the storage component, to obtain the second data.

In a seventh aspect, alone or in combination with one or more of the first through sixth aspects, the computer system includes an embedded system.

In an eighth aspect, alone or in combination with one or more of the first through seventh aspects, the compute component includes an SoC device.

In a ninth aspect, alone or in combination with one or more of the first through eighth aspects, the storage component includes at least one of a memory device or a storage device.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

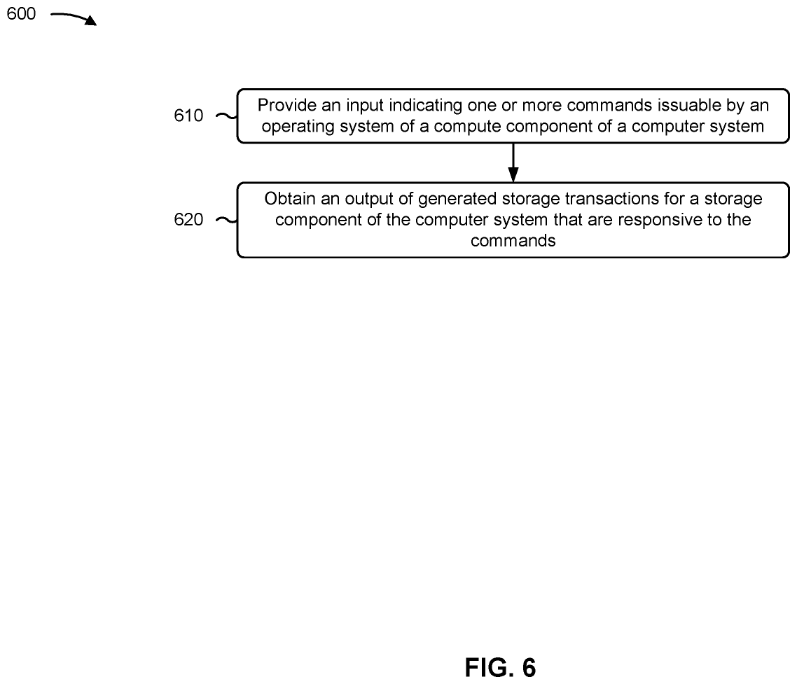

FIG. 6 is a flowchart of an example method 600 associated with using machine learning to generate a workload of a storage component. In some implementations, a device (e.g., the usage device 320) may perform or may be configured to perform the method 600. In some implementations, another device or a group of devices separate from or including the device (e.g., the training device 310, the first database 330, and/or the second database 340) may perform or may be configured to perform the method 600. Additionally, or alternatively, one or more components of the device may perform or may be configured to perform the method 600. Thus, means for performing the method 600 may include the device and/or one or more components of the device. Additionally, or alternatively, a non-transitory computer-readable medium may store one or more instructions that, when executed by the device, cause the device to perform the method 600.

As shown in FIG. 6, the method 600 may include providing an input indicating one or more commands issuable by an operating system of a compute component of a computer system (block 610). As further shown in FIG. 6, the method 600 may include obtaining an output of generated storage transactions for a storage component of the computer system that are responsive to the commands (block 620).

The method 600 may include additional aspects, such as any single aspect or any combination of aspects described below and/or described in connection with one or more other methods or operations described elsewhere herein.

In a first aspect, the input further indicates a hardware configuration of the computer system.

In a second aspect, alone or in combination with the first aspect, the input further indicates an application configuration of the computer system.

In a third aspect, alone or in combination with one or more of the first and second aspects, the method 600 includes providing the generated storage transactions to a simulator for the computer system or an emulator for the computer system.

In a fourth aspect, alone or in combination with one or more of the first through third aspects, the method 600 includes adjusting a configuration of at least one of the compute component or the storage component based on the generated storage transactions.

In a fifth aspect, alone or in combination with one or more of the first through fourth aspects, the machine learning model includes a VAE model or a conditional VAE.

In a sixth aspect, alone or in combination with one or more of the first through fifth aspects, the machine learning model includes a GAN model or a conditional GAN model.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a method includes obtaining, by a device, first data relating to commands issued by an operating system of a compute component of a computer system for a storage component of the computer system; obtaining, by the device, second data relating to transactions at the storage component that are responsive to the commands; and providing the first data and the second data to train a machine learning model to output generated storage transactions based on an input of operating system commands.

In some implementations, a method includes providing, by a device to a machine learning model, an input indicating one or more commands issuable by an operating system of a compute component of a computer system; and obtaining, by the device from the machine learning model, an output of generated storage transactions for a storage component of the computer system that are responsive to the commands.

In some implementations, a device includes one or more memories; and one or more processors, communicatively coupled to the one or more memories, configured to: provide, to a machine learning model, an input indicating one or more commands issuable by an operating system of a compute component; and obtain, from the machine learning model, an output of generated storage transactions for a storage component that are responsive to the commands.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining, by a device, first data relating to commands issued by an operating system of a compute component of a computer system for a storage component of the computer system;
obtaining, by the device, second data relating to transactions at the storage component that are responsive to the commands; and
providing the first data and the second data to train a machine learning model to output generated storage transactions based on an input of operating system commands.

2. The method of claim 1, wherein providing the first data and the second data to train the machine learning model comprises:
providing the first data, the second data, and third data to train the machine learning model,
wherein the third data indicates a hardware configuration of the computer system.

3. The method of claim 2, wherein the third data further indicates an application configuration of the computer system.

4. The method of claim 1, wherein obtaining the first data comprises:
obtaining the first data by monitoring, via an application executing on the compute component, the commands,
wherein the commands are for block storage.

5. The method of claim 1, wherein obtaining the first data comprises:
obtaining the first data by monitoring, via an application executing on the compute component, the commands,
wherein the commands are indicated by at least one of a page cache or kernel content stored in memory.

6. The method of claim 1, wherein an interposer is disposed between the storage component and a circuit board of the computer system,
wherein the interposer is configured to route electrical signals communicated by the storage component to a location external to the computer system.

7. The method of claim 1, wherein obtaining the second data comprises:
obtaining electrical signal data by monitoring, via an interposer connected to the storage component, electrical signals communicated at the storage component; and
converting the electrical signal data to one or more data and command transactions for the storage component, to obtain the second data.

8. The method of claim 1, wherein the computer system comprises an embedded system.

9. The method of claim 1, wherein the compute component comprises a system-on-chip (SoC) device.

10. The method of claim 1, wherein the storage component comprises at least one of a memory device or a storage device.

11. A method, comprising:
providing, by a device to a machine learning model, an input indicating one or more commands issuable by an operating system of a compute component of a computer system; and
obtaining, by the device from the machine learning model, an output of generated storage transactions for a storage component of the computer system that are responsive to the commands.

12. The method of claim 11, wherein the input further indicates a hardware configuration of the computer system.

13. The method of claim 12, wherein the input further indicates an application configuration of the computer system.

14. The method of claim 11, further comprising:
providing the generated storage transactions to a simulator for the computer system or an emulator for the computer system.

15. The method of claim 11, further comprising:
adjusting a configuration of at least one of the compute component or the storage component based on the generated storage transactions.

16. The method of claim 11, wherein the machine learning model comprises a variational autoencoder model or a conditional variational autoencoder model.

17. The method of claim 11, wherein the machine learning model comprises a generative adversarial network model or a conditional generative adversarial network model.

18. A device, comprising:
one or more memories; and
one or more processors, communicatively coupled to the one or more memories, configured to:
provide, to a machine learning model, an input indicating one or more commands issuable by an operating system of a compute component; and
obtain, from the machine learning model, an output of generated storage transactions for a storage component that are responsive to the commands.

19. The device of claim 18, wherein the input further indicates at least one of a hardware configuration of the compute component or an application configuration of the compute component.

20. The device of claim 18, wherein the one or more processors are further configured to:
adjust a configuration of at least one of the compute component or the storage component based on the generated storage transactions.
